(19) United States
(12) Patent Application Publication
(10) Pub. No.: US 2009/0231847 A1
(43) Pub. Date: Sep. 17, 2009

(54) LED ILLUMINATING DEVICE

(75) Inventors: John-Chungteh PAN, Taichung Hsien (TW); Micheler Jhu, Taipei County (TW); Karl Lai, Taichung City (TW)

Correspondence Address: BROWDY AND NEIMARK, P.L.L.C.;624 NINTH STREET, NW, SUITE 300, WASHINGTON, DC, 20001-5303, US

(73) Assignee: FORHOUSE CORPORATION, Taichung Hsien (TW)

(21) Appl. No.: 12/115,929

(22) Filed: May 6, 2008

(30) Foreign Application Priority Data
Mar. 14, 2008 (TW) 97109248

(51) Int. Cl. F21V 7/04; F21V 11/00

(52) U.S. Cl. 362/240; 362/613

(57) ABSTRACT

A LED illuminating device includes a substrate, a plurality of blue LEDs mounted on the substrate, and an optical layer, which is kept a predetermined distance from the blue LEDs, for diffusing rays of the blue LEDs and for converting the rays of the blue LEDs to white light, or at least diffusing the rays and converting the rays to white light in the same time. The LED illuminating device may be incorporated in a direct-light backlight module or an edge-light backlight module to provide a light source with higher brightness and more uniform brightness and hue distributions.

### BACKGROUND OF THE INVENTION

1. Field of the Invention

The present invention relates generally to an illuminating device, and more particularly to a LED illuminating device.

2. Description of the Related Art

Light emitting diodes (LED), with advantages of lower power consumption and higher illumination efficiency, are more and more popular to be used as a light source. The conventional LED includes a chip, which is the light emitting unit, and an enclosure encapsulating the chip therein. In conventional semiconductor process, the chips of LED are cut from a wafer, and the chips on the same wafer have different properties, such as the driving voltage, the peak wavelength, the brightness, and so on that make individual chips have different optical and electrical properties, so that the chips will be classified into different classes, a class is known as a bin. When someone would accept the less numbers of bins, the cost gets higher.

More and more liquid crystal displays (LCDs) use white-light LEDs to be the light sources of the backlight modules (BLMs). The conventional backlight modules using white-light LEDs have following drawbacks. LED is a kind of the point light sources. When the backlight module has white-light LEDs as the light source, LEDs are mounted on a substrate by surface mount technology (SMT) to form a substantial line or surface light source for backlight modules. Due to the limitation of manufacture, the white-light LEDs would suffer the position errors, the angle deviations of its optical axis and the gaps between neighboring ones, those cause the curtain mura and the non-uniform brightness distribution. Furthermore, in traditional packaging design of the white-light LEDs, the chip emitting blue rays is changed to white light first, then performs mixing and collimation, divergence, or convergence. Due to white light contains many different wavelength rays, and the optical properties of material depend on the wavelengths, the dispersion phenomenon raises, and causes a non-uniform hue distribution. When the white light LEDs are adopted as the light sources of the backlight modules, the non-uniform brightness distribution and hue distribution will make users have unpleasure viewing experience.

### SUMMARY OF THE INVENTION

The primary objective of the present invention is to provide a LED illuminating device and a backlight module incorporated with the LED illuminating device, which the LEDs may have various optical properties.

The secondary objective of the present invention is to provide a LED illuminating device and a backlight module incorporated with the LED illuminating device, which has less non-uniform brightness distribution and non-uniform hue distribution.

According to the objective of the present invention, a LED illuminating device includes a substrate having a circuit, a plurality of blue LEDs mounted on the substrate and electrically connected to the circuit, and an optical layer, which is kept a predetermined distance from the blue LEDs, for diffusing rays of the blue LEDs and for converting the rays of the blue LEDs to white light.

The LED illuminating device of the present invention may be incorporated in a direct-light backlight module, which includes a frame including a bottom plate and an annular wall, a substrate, which has a circuit, mounted on the bottom plate of the frame, a plurality of blue LEDs mounted on the substrate and electrically connected to the circuit, and an optical layer, which is mounted on the frame and is kept a predetermined distance from the blue LEDs, for diffusing rays of the blue LEDs and for converting the rays of the blue LEDs to white light LEDs.

The LED illuminating device of the present invention also may be incorporated in an edge-light backlight module, which includes a light guide plate and a light source mounted in front of an entry side of the light guide plate, wherein the light source includes a substrate having a circuit, a plurality of blue LEDs mounted on the substrate and electrically connected to the circuit, and an optical layer, which is kept a predetermined distance from the blue LEDs, for diffusing light of the blue LEDs and for converting the rays of the blue LEDs to white light LEDs.

### BRIEF DESCRIPTION OF THE DRAWINGS

FIG. 1 is an exploded view of a first preferred embodiment of the present invention;

FIG. 2 is a sectional view of the first preferred embodiment of the present invention;

FIG. 3 is a sectional view of a second preferred embodiment of the present invention;

FIG. 4 is a sectional view of a third preferred embodiment of the present invention;

FIG. 5 is a sectional view of a fourth preferred embodiment of the present invention;

FIG. 6 is a perspective view of a fifth preferred embodiment of the present invention; and

FIG. 7 is a sectional view of the fifth preferred embodiment of the present invention.

### DETAILED DESCRIPTION OF THE INVENTION

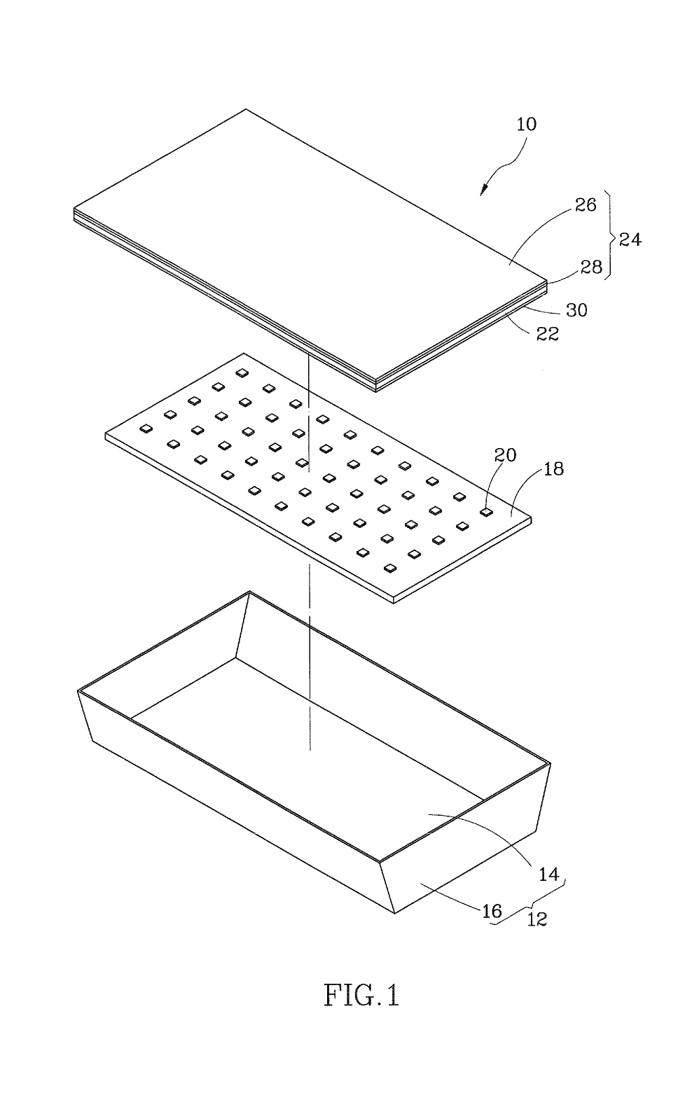

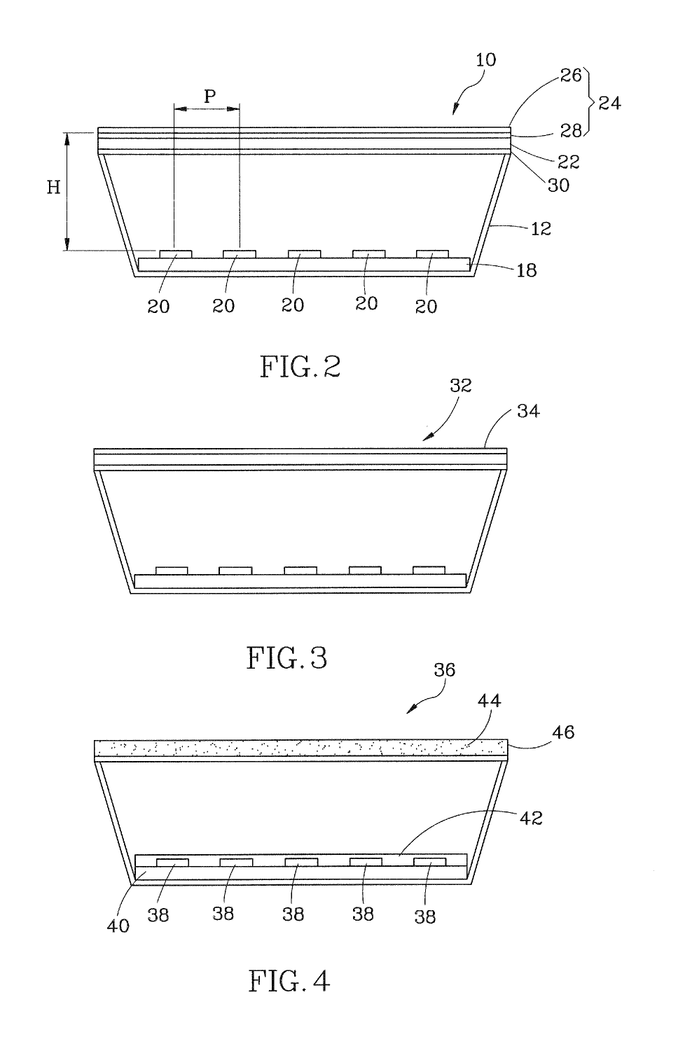

As shown in FIG. 1 and FIG. 2, a light emitting diode (LED) illuminating device of the preferred embodiment of the present invention is incorporated in a direct-light backlight module 10, which includes:

A frame 12 includes a bottom plate 14 and an annular wall 16.

A substrate 18, which has a circuit (not shown) thereon, is mounted on the bottom plate 14 of the frame 12.

A plurality of blue light emitting diodes (blue LED) 20 are mounted on the substrate 18 in a matrix layout and are electrically connected to the circuit. The blue LEDs here are packed LEDs.

A diffusing plate 22 is mounted on a top of the annular wall 16 of the frame 12. The diffusing plate 22 is kept a predetermined distance (H) from the blue LEDs 20. The diffusing plate 22 has an optical layer 24 and a filter layer 30 at opposite sides. The optical layer 24 has a converting layer 26 and a diffusing layer 28. The diffusing layer 28 is closer to the blue LEDs 20 than the converting layer 26. The diffusing layer 28 has diffusing particles therein to diffuse light traveling therethrough, and the converting layer has phosphor powder to convert blue light to whit light. The filter layer 30 may reflect the rays with wavelengths greater than 530 nm. The blue LEDs 20 emit blue light traveling through the filter layer 30, the diffusing layer 28 and the converting layer 26 in sequence.

The present invention provides the blue LEDs 20 in matrix layout that the blue LEDs 20 may have brightness in a wider range. In practice, the tolerance of brightness of the blue LEDs 20 is about ±10%. Even more when a few of blue LEDs 20 damage, the present invention still can provide a uniform light source. It can reduce the cost of LEDs due to the more brightness tolerance.

In general, the blue LEDs 20 of the present invention are the LED emitting rays with narrow spectrum or the single color rays. In the present invention, the blue LEDs 20 emit blue rays with the peak wavelength between 400 nm and 480 nm. The circuit on the substrate 18 provides the blue LEDs 20 power to emit blue rays. The blue rays travel through the filter layer 30 first, which could reflect the rays with wavelength greater than 530 nm, and transmit the other rays (wavelength under 530 nm), and arrive at the optical layer 24. The diffusing layer 28 of the optical layer 24 will diffuse the rays through the filter layer 30 first, and the diffused rays will be converted to white light in the converting layer 26. As a result, the direct-light backlight module 10 of the present invention will provide a uniform surface white light.

Because the rays traveling through the diffusing layer 28 are the blue rays with very narrow spectrum, which means the refractive indices of the material for the entire blue rays are almost the same, therefore there is less dispersion in the diffusing layer 28. After that, the blue rays are converted to white light in the converting layer 26 to provide a uniform line or surface white light.

In fact, the phosphor powder in the converting layer, except for converting blue light to white light, is high reflective particles, which means the phosphor powder may diffuse light also. Therefore, as shown in FIG. 3, a direct-light backlight module 32 of the second embodiment of the present invention has an optical layer 34 having only phosphor powder, it serves the same functions as the diffusing layer 28 and the converting layer 26, diffusing and converting light in the same time.

Wavelength of the phosphor powder in the optical layer is chosen according to the emission peak wavelength of the blue LEDs. In our test, the relationship of the wavelength of the phosphor powder and the wavelength of light of the blue LEDs is shown in the following table:

| | Emission wavelength |
|---|---|
| Emission wavelength of phosphor powder | of the light of blue LED |
| 525~535 nm | 452.5~457.5 nm |
| 535~545 nm | 457.5~462.5 nm |
| 545~555 nm | 462.5~467.5 nm |
| 550~560 nm | 467.5~472.5 nm |

It has to be mentioned here that the optical layer (or the phosphor powder layer) has to keep a predetermined distance from the blue LEDs. In optical theory, the distance between the optical layer and the blue LEDs is positive relative to a uniform distributed light source. But in a limited size of backlight module, a distance (H) between the optical layer and the blue LEDs is relative to a distance (P) between the neighboring blue LEDs, referring to FIG. 2. According to our experience, the distance (H) between the optical layer and the blue LEDs is 1.5 times greater than the distance (P) between the neighboring blue LEDs, or greater.

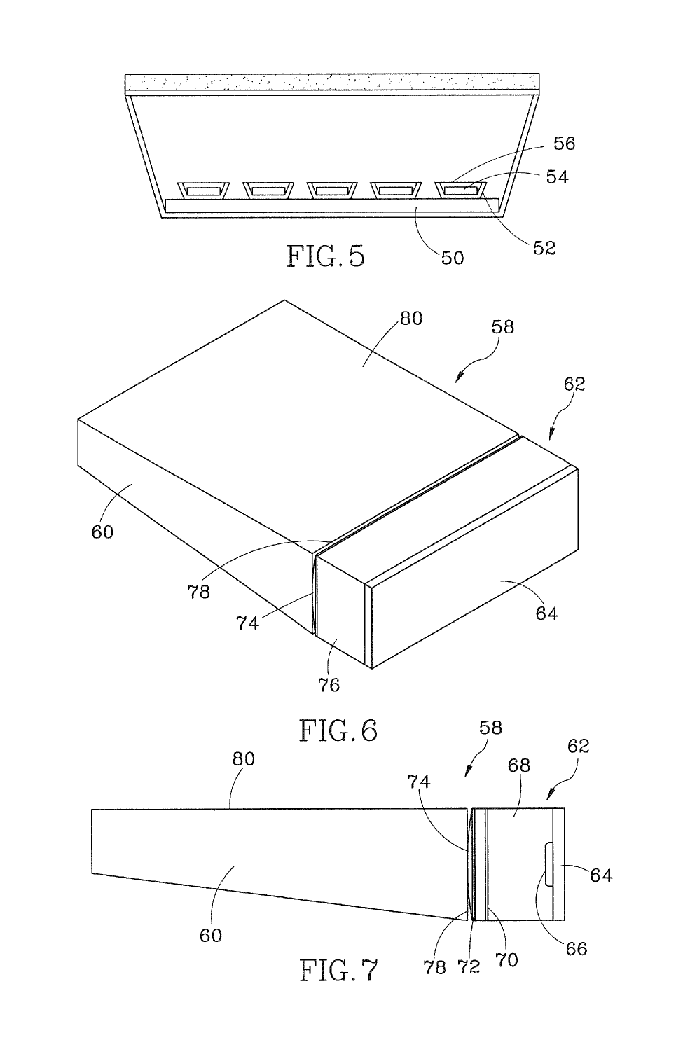

FIG. 4 shows a direct-light backlight module 36, which is similar to the backlight module 32 of FIG. 3. The differences are: unpacked LED chips 38 are mounted on a substrate 40, and a protective layer 42 is coated on the substrate 40 to cover the LED chips 38. The protective layer 42 may be epoxy, silicon, or other relative materials. A diffusing plate 44 is doped with phosphor powder 44. Another direct-light backlight module, as shown in FIG. 5, is provided with cup-like walls 52 on a substrate 50 and LED chips are mounted in the walls 52 respectively, and then epoxy is filled in the walls 52 to form protective layers 56.

The LED illuminating device of the present invention may be incorporated in an edge-light backlight module. As shown in FIG. 6 and FIG. 7, an edge-light backlight module 58 includes a light guide plate 60 and a light source 62 incorporated with the LED illuminating device of the present invention. The light source 62 includes a substrate 64 having a circuit (not shown), a plurality of blue LEDs 66 mounted on the substrate 64, an separating layer 68 with a predetermined width provided on the substrate 64 and covering the blue LEDs 66, a filter layer 70 provided on the separating layer 68 and an optical layer 72 provided on the filter layer 70. The separating layer 68 may be epoxy, silicon, or other relative materials. The filter layer 70 is closer to the blue LEDs 66 than the optical layer 72. The optical layer 72 is a phosphor powder layer. The edge-light backlight module 58 further has a lens layer on the optical layer 72 facing an enter side 78 of the light guide plate 60. The light 62, except the lens layer 74, is coated with a reflective layer 76. The light 68 provides white light entering the light guide plate 60 via the enter side 78 and traveling out via an exit side 80 at a top of the light guide plate 80.

The light 62 serve the same function as described above. The lens layer 74 is a convex lens in the present embodiment to change paths of the white light to a parallel direction.

In conclusion, the main character of the present invention is that the blue LEDs provide rays with narrow spectrum. The rays are diffused, and then are converted to white light, or the rays are diffused and converted in a single optical layer. It may provide a uniform light source with higher brightness and more uniform hue.

What is claimed is:

1. A LED illuminating device, comprising:
a substrate having a circuit;
a plurality of blue LEDs mounted on the substrate and electrically connected to the circuit; and
an optical layer, which is kept a predetermined distance from the blue LEDs, for diffusing rays of the blue LEDs and for converting the rays of the blue LEDs to white light.

2. The LED illuminating device as defined in claim 1, wherein the optical layer includes a diffusing layer, in which diffusing particles are provided, to diffuse the rays of blue LEDs and a converting layer, in which phosphor powder is provided, to convert the rays of the blue LEDs to white light, and the diffusing layer is closer to the blue LEDs than the converting layer.

3. The LED illuminating device as defined in claim 1, wherein the optical layer has phosphor powder therein to diffuse the rays and to convert the rays to white light in the same time.

4. The LED illuminating device as defined in claim 1, wherein the blue LEDs include a plurality of LED chips provided on the substrate and electrically connected to the circuit and a protective layer provided on the substrate to cover the LED chips.

5. The LED illuminating device as defined in claim 1, wherein the substrate is provided with a plurality of walls, in which the LED chips and the protective layer are provided respectively.

6. The LED illuminating device as defined in claim 1, further comprising a separating layer between the optical and the blue LEDs.

7. The LED illuminating device as defined in claim 1, further comprising a filter layer to filter the rays of the blue LEDs, wherein the filter layer is closer to the blue LEDs than the optical layer.

8. The LED illuminating device as defined in claim 1, further comprising a lens layer to change paths of the rays, wherein the optical layer is closer to the blue LEDs than the lens layer.

9. A direct-light backlight module, comprising:
a frame including a bottom plate and an annular wall;
a substrate, which has a circuit, mounted on the bottom plate of the frame;
a plurality of blue LEDs mounted on the substrate and electrically connected to the circuit; and
an optical layer, which is mounted on the frame and is kept a predetermined distance from the blue LEDs, for diffusing rays of the blue LEDs and for converting the rays of the blue LEDs to white light.

10. The direct-light backlight module as defined in claim 9, wherein the optical layer includes a diffusing layer, in which diffusing particles are provided, to diffuse the rays of blue LEDs and a converting layer, in which phosphor powder is provided, to convert the rays of the blue LEDs to white light, and the diffusing layer is closer to the blue LEDs than the converting layer.

11. The direct-light backlight module as defined in claim 9, wherein the optical layer has phosphor powder therein to diffuse the rays and to convert the rays to white light in the same time.

12. The direct-light backlight module as defined in claim 9, wherein the blue LEDs include a plurality of LED chips provided on the substrate and electrically connected to the circuit and a protective layer provided on the substrate to cover the LED chips.

13. The direct-light backlight module as defined in claim 9, wherein the substrate is provided with a plurality of walls, in which the LED chips and the protective layer are provided respectively.

14. The direct-light backlight module as defined in claim 9, further comprising a filter layer to filter the rays of the blue LEDs, wherein the filter layer is closer to the blue LEDs than the optical layer.

15. An edge-light backlight module, comprising a light guide plate and a light source mounted in front of an enter side of the light guide plate, wherein the light source includes a substrate having a circuit, a plurality of blue LEDs mounted on the substrate and electrically connected to the circuit, and an optical layer, which is kept a predetermined distance from the blue LEDs, for diffusing rays of the blue LEDs and for converting the rays of the blue LEDs to white light.

16. The edge-light backlight module as defined in claim 15, wherein the optical layer includes a diffusing layer, in which diffusing particles are provided, to diffuse the rays of blue LEDs and a converting layer, in which phosphor powder is provided, to convert the rays of the blue LEDs to white light, and the diffusing layer is closer to the blue LEDs than the converting layer.

17. The edge-light backlight module as defined in claim 15, wherein the optical layer has phosphor powder therein to diffuse the rays and to convert the rays to white light in the same time.

18. The edge-light backlight module as defined in claim 15, further comprising a separating layer between the optical layer and the blue LEDs.

19. The edge-light backlight module as defined in claim 15, further comprising a filter layer to filter the rays of the blue LEDs, wherein the filter layer is closer to the blue LEDs than the optical layer.

20. The edge-light backlight module as defined in claim 15, further comprising a lens layer to change paths of the rays, wherein the optical layer is closer to the blue LEDs than the lens layer.
